(19) United States
(12) Patent Application Publication
(10) Pub. No.: US 2025/0334830 A1
(43) Pub. Date: Oct. 30, 2025

(54) LIQUID CRYSTAL DISPLAY DEVICE AND METHOD FOR CONTROLLING LIQUID CRYSTAL DISPLAY DEVICE

(71) Applicant: Sharp Display Technology Corporation, Kameyama City (JP)

(72) Inventors: Hideki KOBAYASHI, Kameyama City (JP); Hiroto AKIYAMA, Kameyama City (JP)

(21) Appl. No.: 19/188,335

(22) Filed: Apr. 24, 2025

(30) Foreign Application Priority Data
Apr. 26, 2024 (JP) 2024-072389

(51) Int. Cl. G02F 1/133; G02F 1/1362

(52) U.S. Cl. CPC G02F 1/13306; G02F 1/136286

(57) ABSTRACT

A liquid crystal display device includes a plurality of gate bus lines, a plurality of source bus lines, and a plurality of pixels arranged in a display region, a source drive circuit, and a timing controller. The display region extends in a column direction and includes a plurality of first polarity regions and a plurality of second polarity regions alternately arranged in a row direction, the timing controller controls the source drive circuit to ensure that polarities of data signals each output to a pair of source bus lines are the same. The pair of source bus lines are included in one of the plurality of first polarity regions and one of the plurality of second polarity regions, respectively and are adjacent to each other.

### CROSS-REFERENCE TO RELATED APPLICATIONS

This application claims the benefit of priority to Japanese Patent Application Number 2024-072389 filed on Apr. 26, 2024. The entire contents of the above-identified application are hereby incorporated by reference.

### BACKGROUND

### Technical Field

The disclosure relates to a liquid crystal display device and a method for controlling a liquid crystal display device.

A liquid crystal layer used in the liquid crystal display device has characteristics of deteriorating easily when a voltage of the same polarity is continuously applied. For this reason, the liquid crystal display device is generally configured to operate by AC driving.

An AC driving method includes frame-reversal driving, row line reversal driving, column line reversal driving, dot inversion drive, and the like, and an appropriate driving method is selected in consideration of the characteristics of the liquid crystal layer used in the liquid crystal display device, the application of the liquid crystal display device, and the like.

However, depending on the AC driving method employed, when a specific image pattern is displayed on the liquid crystal display device, the color on the display screen is not the correct color and may be tinged with a different color. This sort of display is referred to as a color shift. The color shift is referred to as a greenish phenomenon, particularly when being tinged with a green color. The image pattern in which the color shift is likely to occur is called a killer pattern.

For example, JP 2005-258447 A and WO 2018/128142 disclose a liquid crystal display device capable of suppressing such color shift.

### SUMMARY

An object of the disclosure is to provide a liquid crystal display device and a method for controlling a liquid crystal display device that can suppress such color shift.

A liquid crystal display device according to an embodiment of the disclosure includes a plurality of gate bus lines arranged in a display region, each extending in a row direction and arrayed in a column direction, a plurality of source bus lines arranged in the display region, each extending in the column direction and arrayed in the row direction, a plurality of pixels two-dimensionally arranged in the row direction and the column direction in the display region, each of the plurality of pixels being connected to one of the plurality of gate bus lines and one of the plurality of source bus lines, a source drive circuit connected to the plurality of source bus lines and configured to output a plurality of data signals to each of the plurality of source bus lines by a column line reversal driving method or a dot inversion drive method, and a timing controller configured to control the source drive circuit, in which the display region includes a plurality of first polarity regions and a plurality of second polarity regions extending in the column direction and alternately arranged in the row direction, and the timing controller is configured to control the source drive circuit to ensure that polarities of the data signals each output to a pair of source bus lines are the same, the pair of source bus lines being included in one of the plurality of first polarity regions and one of the plurality of second polarity regions, respectively and adjacent to each other.

According to an embodiment of the disclosure, there is provided a liquid crystal display device and a method for controlling a liquid crystal display device that can suppress the color shift when the killer pattern is displayed.

### BRIEF DESCRIPTION OF DRAWINGS

The disclosure will be described with reference to the accompanying drawings, wherein like numbers reference like elements.

FIG. 1 is a schematic cross-sectional view illustrating a configuration example of a liquid crystal display device according to an embodiment.

FIG. 2 is a schematic diagram illustrating a configuration of a TFT substrate in the liquid crystal display device illustrated in FIG. 1.

FIG. 3 is a circuit diagram illustrating a pixel PX of the TFT substrate driven by a column line reversal driving method.

FIG. 4 is a circuit diagram illustrating the pixel PX of the TFT substrate driven by a 1H dot inversion drive method.

FIG. 5 is a circuit diagram illustrating the pixel PX of the TFT substrate driven by a 2H dot inversion drive method.

FIG. 6 is a schematic diagram illustrating an arrangement of red pixels, green pixels and blue pixels in the liquid crystal display device.

FIG. 7 is a block diagram illustrating a configuration example of a control device.

FIG. 8 is a schematic diagram illustrating a distribution example of a first and second polarity regions in an entire display region.

FIG. 9 illustrates a relationship between the first and second polarity regions and polarities of data signals output to source bus lines.

FIG. 10 is a schematic diagram illustrating an example of the polarities of the data signals output from two source driver chips.

FIG. 11 is a schematic diagram illustrating an example of the polarities of the data signals output from the two source driver chips.

FIG. 12 is a schematic diagram illustrating an example of the polarities of the data signals output from the two source driver chips.

FIG. 13A is a schematic diagram illustrating the polarities of the data signals applied in a certain frame period in a case in which a known liquid crystal display device is driven by the column line reversal driving method.

FIG. 13B is a schematic diagram illustrating the polarities of the data signals applied in a certain frame period in a case in which the known liquid crystal display device is driven by the column line reversal driving method.

FIG. 13C is a schematic diagram illustrating an example of a killer pattern in the column line reversal driving method.

FIG. 14 is a schematic diagram illustrating potential fluctuation of a common electrode.

FIG. 15A is a schematic diagram illustrating the polarities of the data signals applied in a certain frame period in a case in which the known liquid crystal display device is driven by the 1H dot inversion drive method.

FIG. 15B is a schematic diagram illustrating the polarities of the data signals applied in a certain frame period in a case in which the known liquid crystal display device is driven by the 1H dot inversion drive method.

FIG. 15C is a schematic diagram illustrating an example of the killer pattern in the 1H dot inversion drive method.

FIG. 16A is a schematic diagram illustrating the polarities of the data signals applied in a certain frame period in a case in which the known liquid crystal display device is driven by the 2H dot inversion drive method.

FIG. 16B is a schematic diagram illustrating the polarities of the data signals applied in a certain frame period in a case in which the known liquid crystal display device is driven by the 2H dot inversion drive method.

FIG. 16C is a schematic diagram illustrating an example of the killer pattern in the 2H dot inversion drive method.

FIG. 17 illustrates the killer pattern and the polarities of the data signals applied in a certain frame period in a case in which the liquid crystal display device of the present embodiment is driven by the column line reversal driving method.

FIG. 18 illustrates the killer pattern and the polarities of the data signals applied in a certain frame period in a case in which the liquid crystal display device of the present embodiment is driven by the 1H dot inversion drive method.

FIG. 19 illustrates the killer pattern and the polarities of the data signals applied in a certain frame period in a case in which the liquid crystal display device of the present embodiment is driven by the 2H dot inversion drive method.

FIG. 20 illustrates an example of a result of measuring a relationship between a width in a row direction of the first and second polarity regions and a chromaticity difference between the first polarity region and the second polarity region.

### DESCRIPTION OF EMBODIMENTS

Embodiments of the disclosure will be described below with reference to the drawings. The disclosure is not limited to the following embodiments, and appropriate design changes can be made within a scope that satisfies the configuration of the disclosure. Further, in the description below, the same reference signs may be used in common among the different drawings for the same portions or portions having the same or similar functions, and descriptions of repetitions thereof may be omitted. Further, each of the configurations described in the embodiments may be combined or modified as appropriate within a range that does not depart from the gist of the disclosure. For ease of explanation, in the drawings referenced below, configurations may be simplified or schematically illustrated, or a portion of the components may be omitted. Further, dimensional ratios between components illustrated in the drawings are not necessarily indicative of actual dimensional ratios.

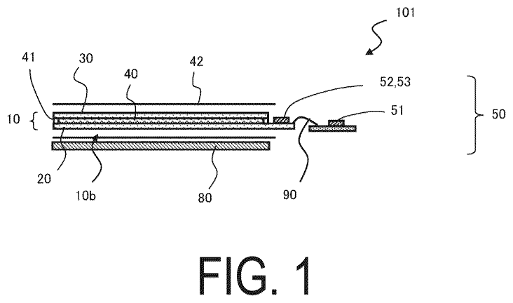

FIG. 1 is a schematic cross-sectional view illustrating a configuration example of a liquid crystal display device 101 according to the present embodiment. The liquid crystal display device 101 includes a liquid crystal panel 10 and a control device 50. The liquid crystal panel 10 includes a TFT substrate 20, a counter substrate 30, and a liquid crystal layer 40. As will be described later, the liquid crystal panel 10 includes a plurality of pixels arrayed in a row direction and in a column direction. The liquid crystal layer 40 is located between the TFT substrate 20 and the counter substrate 30, and is sealed between the TFT substrate 20 and the counter substrate 30 by a seal 41.

The liquid crystal display device 101 may further include a pair of polarizers 42 and a backlight 80. The pair of polarizers 42 are arranged in a crossed-Nicol state with the liquid crystal panel 10 interposed therebetween.

The backlight 80 is arranged on a back surface 10b of the liquid crystal panel 10. The backlight 80 may be an edge-type backlight or a direct backlight. Further, the backlight 80 may be capable of partial driving.

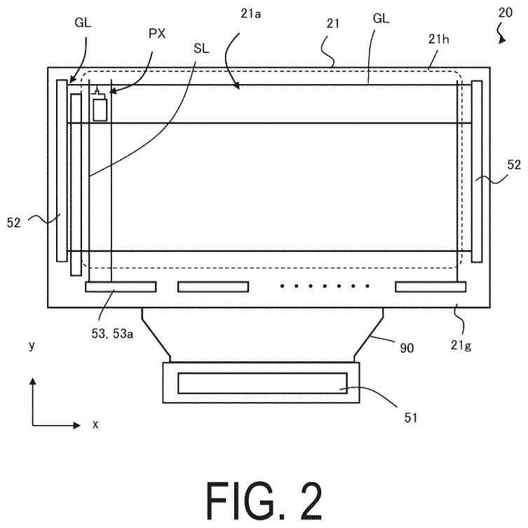

FIG. 2 is a schematic diagram illustrating a configuration example of the TFT substrate 20. The TFT substrate 20 includes a substrate 21, a plurality of source bus lines (data signal line) SL, a plurality of gate bus lines (scanning signal line) GL, and the plurality of pixels PX.

The substrate 21h as a main surface 21a including a display region 21h and a non-display region 21g that is a region other than the display region 21h. The plurality of gate bus lines GL, the plurality of source bus lines SL, and the plurality of pixels PX are arranged in the display region 21h. Specifically, the plurality of gate bus lines GL each extend in the row direction (x direction) and are arranged at predetermined intervals in the column direction (y direction) intersecting the row direction. The plurality of source bus lines SL each extend in the column direction and are arranged at predetermined intervals in the row direction. The pixel PX is arranged in a region surrounded by a pair of the gate bus lines GL adjacent to each other and a pair of the source bus lines SL adjacent to each other. The plurality of pixels PX are two-dimensionally arrayed in the row direction and in the column direction. The source bus lines SL and the gate bus lines GL are extended to the non-display region 21g.

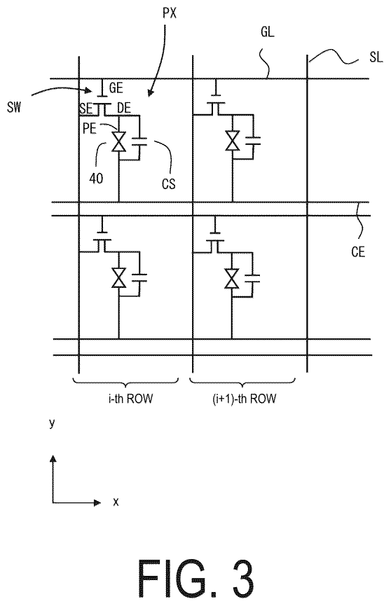

FIG. 3 is a circuit diagram illustrating the pixel PX of the TFT substrate 20 driven by a column line reversal driving method. Each of the pixels PX includes a pixel electrode PE, a switching element SW, and a common electrode CE. The switching element SW is, for example, a thin film transistor (TFT) which is a 3-terminal element, and the gate bus line GL, the source bus line SL, and the pixel electrode PE are connected to the three terminals. For example, the switching element is a TFT including a gate electrode GE, a source electrode SE and a drain electrode DE, with the gate electrode GE connected to the gate bus line GL, the source electrode SE connected to the source bus line SL, and the drain electrode DE connected to the pixel electrode PE and an auxiliary capacity CS. In this way, each of the pixels PX is connected to one of the plurality of gate bus lines GL and one of the plurality of source bus lines SL via the switching element SW.

Each of the gate bus lines GL is connected to the gate electrode GE of the TFT of each of the pixels PX arrayed in the row direction, among the plurality of pixels PX. On the other hand, each of the source bus lines SL is connected to the source electrode SE of the TFT of each of the pixels PX arrayed in the column direction, among the plurality of pixels PX. Therefore, data signals having the same polarity are applied to the plurality of pixels arrayed in the column direction by the reversal driving.

The pixel electrode PE is arranged to face the liquid crystal layer 40. The common electrode CE is, for example, a single plate-like or sheet-like electrode connected to each other between the neighboring pixels PX and extends over an entire display region 21h, and is located between the pixel electrode PE and the substrate 21. An insulating layer is arranged between the common electrode CE and the pixel electrode PE. The common electrode CE are provided in the entire display region 21h. By applying a voltage between the pixel electrode PE and the common electrode CE, an electrical field is generated in the liquid crystal layer 40, and the liquid crystal panel 10 is driven in a transverse electrical field mode such as In Plane Switching (IPS) or Fringe Field Switching (FFS). Thus, the liquid crystal panel 10 with a wide viewing angle can be achieved.

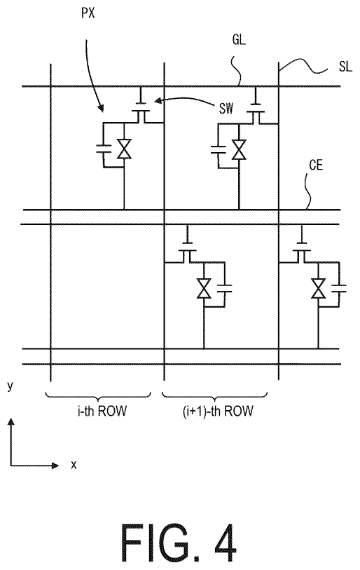

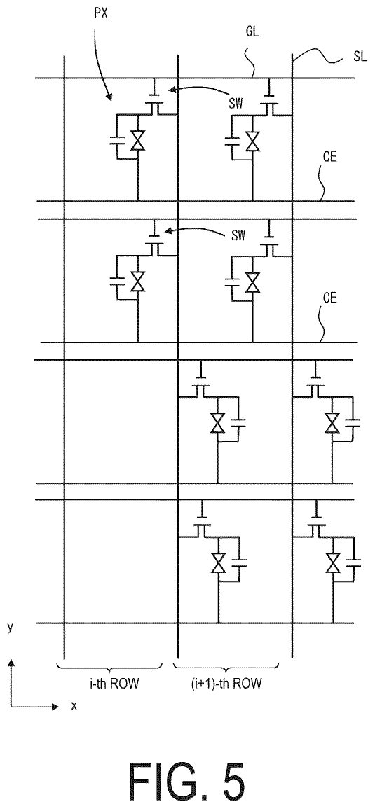

FIGS. 4 and 5 are circuit diagrams illustrating the pixel PX of the TFT substrate 20 driven by a dot inversion drive method. FIG. 4 is a circuit diagram of the TFT substrate 20 driven by a 1H dot inversion drive method, in which pixels PX in the i-th row and pixels PX in the (i+1)-th row are alternately connected to the source bus line SL of the (i+1)-th row. FIG. 5 is a circuit diagram of the TFT substrate 20 driven by a 2H dot inversion drive method, in which the pixels PX in the i-th row and the pixels PX in the (i+1)-th row are alternately connected two by two to the source bus line SL of the (i+1)-th row.

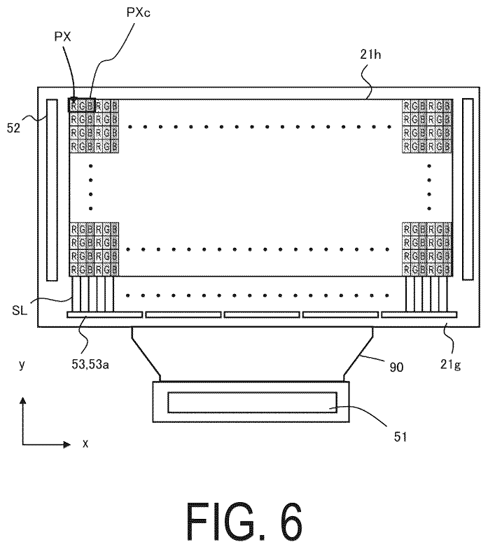

As illustrated in FIG. 6, the plurality of pixels PX include a plurality of red pixels R, a plurality of green pixels G, and a plurality of blue pixels B, and pixels of the same color are arranged in the column direction. In addition, the red pixel R, the green pixel G, and the blue pixel B are repeatedly arranged in this order in the row direction. Three pixels including the red pixel R, the green pixel G, and the blue pixel B adjacent to each other in the row direction constitute a color pixel PXc capable of presenting an achromatic color and an arbitrary color. The red pixel R, the green pixel G, and the blue pixel B may be referred to as subpixels, and a group of these three subpixels may be referred to as a pixel.

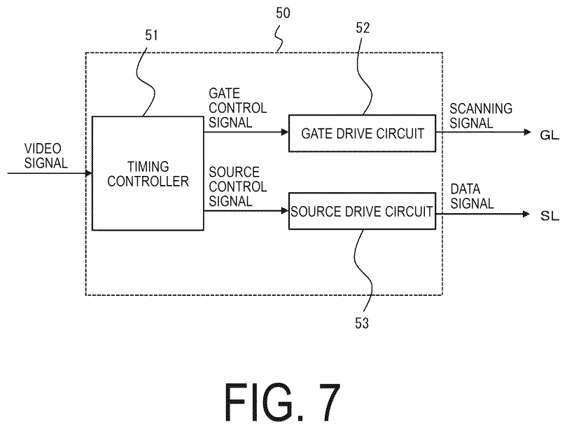

FIG. 7 is a block diagram illustrating a configuration example of the control device 50. The control device 50 includes a timing controller 51, a gate drive circuit 52, and a source drive circuit 53. The control device 50 is configured by an electronic circuit using active components such as ICs, LSIs, and FETs, passive components such as resistors, capacitors, and the like.

The timing controller 51 receives a video signal from an external source. The video signal includes a video data signal and a video synchronization signal. The timing controller 51 generates a gate control signal and a source control signal based on the received video signal.

The gate control signal includes, for example, a gate start pulse signal, a gate clock signal, a gate clear signal, a gate output signal, and the like. The source control signal includes, for example, a source start pulse signal, a source shift clock signal, a source output signal, a polarity signal, and the like.

As illustrated in FIG. 2, the gate drive circuit 52 and the source drive circuit 53 are arranged in the non-display region 21g of the substrate 21. The gate drive circuit 52 is connected to at least one end of the gate bus line GL. The source drive circuit 53 is connected to one end of the source bus line SL. The timing controller 51 is, for example, connected by a Flexible Printed Circuit (FPC) 90.

The gate drive circuit 52 and the source drive circuit 53 are package components covered by resin or the like, or bare chips, and may be mounted in the non-display region 21g of the substrate 21. Alternatively, the gate drive circuit 52 and the source drive circuit 53 may be monolithic drivers constituted by the plurality of TFTs or the like fabricated in the non-display region 21g of the substrate 21.

In the present embodiment, the gate drive circuit 52 is arranged at both ends of the gate bus line GL, and is a monolithic driver configured integrally with the substrate 21 by the TFT or the like formed on the substrate 21, similarly to the TFT which is the switching element SW of the pixel PX. On the other hand, in the present embodiment, the source drive circuit 53 includes a plurality of source driver chips 53a. The source driver chip 53a is a bare chip and is mounted on the substrate 21.

The gate drive circuit 52 receives the gate control signal, generates a plurality of scanning signals, and outputs the generated signals to the plurality of gate bus lines GL, respectively. The source drive circuit 53 receives the source control signal and outputs a plurality of data signals to the source bus lines SL, respectively. The plurality of data signals include voltage values corresponding to gray scale display of each pixel. Since the liquid crystal display device 101 is driven by the column line reversal driving method or the dot inversion drive method, the polarities of the data signals output to the plurality of source bus lines SL arranged in the row direction are alternately inverted.

However, among the plurality of source bus lines SL, there are a plurality of locations to which the data signals having the same polarity are output in the pair of source bus lines SL adjacent to each other. Since the source bus lines SL to which the data signals having the same polarity are applied continue, the display region 21h of the liquid crystal display device 101 includes two polarity regions in which the polarity of the AC driving is inverted.

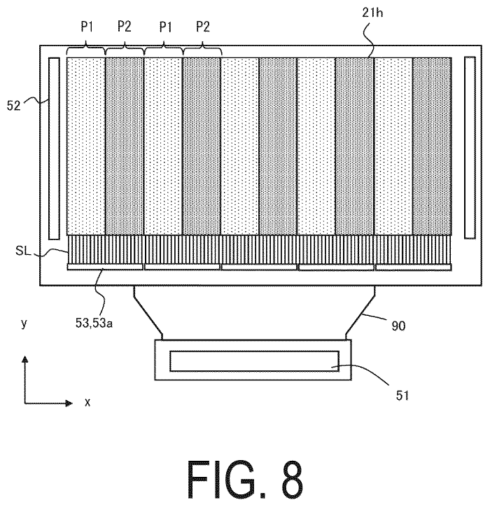

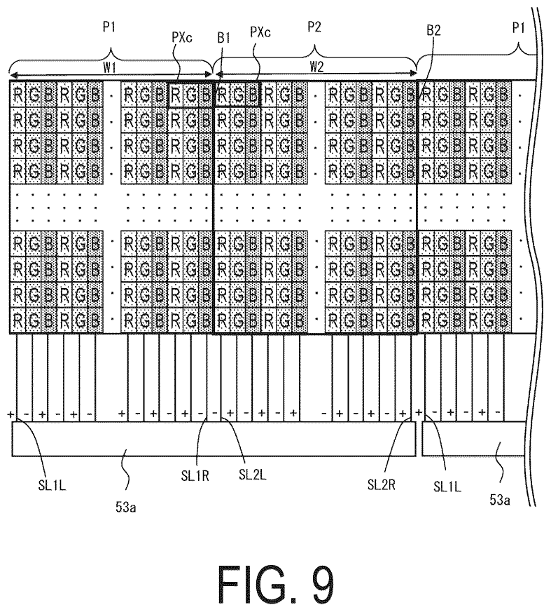

FIG. 8 illustrates distribution of the two polarity regions in the entire display region 21h, and FIG. 9 illustrates a relationship between the polarity regions and the polarities of the data signals output to the source bus lines SL. The display region 21h of the liquid crystal display device 101 includes a plurality of first polarity regions P1 and a plurality of second polarity regions P2. Each of the plurality of first polarity regions P1 and the plurality of second polarity regions P2 extends in the column direction and are alternately arranged in the row direction.

The source drive circuit 53 outputs the data signals to the source bus lines SL to ensure that the polarities of the data signals, each of which is included in the first polarity region P1 and second polarity region P2 adjacent to each other and is respectively output to the pair of source bus lines SL adjacent to each other, are the same. For example, as illustrated in FIG. 9, at a boundary B1 between the second polarity region P2 and the first polarity region P1 adjacent to the second polarity region P2 on the left side thereof in a certain frame period, negative (−) data signals are output to a pair of source bus lines SL1R and SL2L adjacent to each other. At a boundary B2 between the second polarity region P2 and the first polarity region P1 adjacent to the second polarity region P2 on the right side thereof, positive (+) data signals are output to a pair of source bus lines SL2R and SL1L adjacent to each other.

Of the source bus lines SL included in the first polarity region P1 and the second polarity region P2, the polarities of the data signals output to the source bus lines located at both ends (SL1L and SL1R and/or SL2L and SL2R) may be the same polarity or different polarities. In the example illustrated in FIG. 9, in each of the first polarity region P1 and the second polarity region P2, the polarities of the data signals output to the source bus lines SL located at both ends are different from each other. In the first polarity region P1 and the second polarity region P2, the polarities of the data signals output to the plurality of source bus lines SL arranged in the row direction are alternately inverted. In the next frame period, the polarities of the above-described data signals are inverted.

The boundary (B1, B2) between the first polarity region P1 and the second polarity region P2 is preferably located between the color pixel PXc and the color pixel PXc described above. For example, as illustrated in FIG. 9, in a case in which the color pixels are formed in the order of the red pixel R, the green pixel G, and the blue pixel B in the row direction, it is preferable that the boundaries B1 and B2 be located between the blue pixel B and the red pixel R. That is, the pair of source bus lines described above to which the data signals of the same polarity are output (SL1L and SL1R and/or SL2L and SL2R) are preferably located in the red pixel R and the blue pixel B, respectively.

The display region 21h preferably includes the plurality of first polarity regions P1 and the plurality of second polarity regions P2. As will be described later, since the display region 21h includes the plurality of first polarity regions P1 and the plurality of second polarity regions P2, the influence of the color shift occurring when a killer pattern is displayed can be further suppressed. In a case in which pixel density of the liquid crystal display device 101 is equal to or higher than 200 pixels per inch, widths W1 and W2 in the row direction of the plurality of first polarity regions P1 and the plurality of second polarity regions P2 are preferably each equal to or less than 15 mm. The width W1 of the first polarity region P1 and the width W2 of the second polarity region P2 may be the same or different from each other. Further, the plurality of first polarity regions P1 may have the same width W1 or different widths from each other. The same applies to the second polarity regions P2. In terms of more efficiently suppressing the color shift, it is preferable that the total value of the widths W1 of the plurality of first polarity regions P1 be equal to the total value of the widths W2 of the plurality of second polarity regions P2.

In the present embodiment, the source driver chip 53a outputs the data signals to the source bus lines SL located in the first polarity region P1 and the second polarity region P2. For this reason, the timing controller 51 is programmed by using, for example, an EPROM so that the data signals of the same polarity are output to the source bus lines SL1R and SL2L and/or SL2R and SL1L and the polarities of the data signals output to the other source bus lines SL arranged in the row direction are alternately inverted. The polarities of the data signals output to the pair of source bus lines SL adjacent to each other between the source driver chips 53a may be the same or may be inverted.

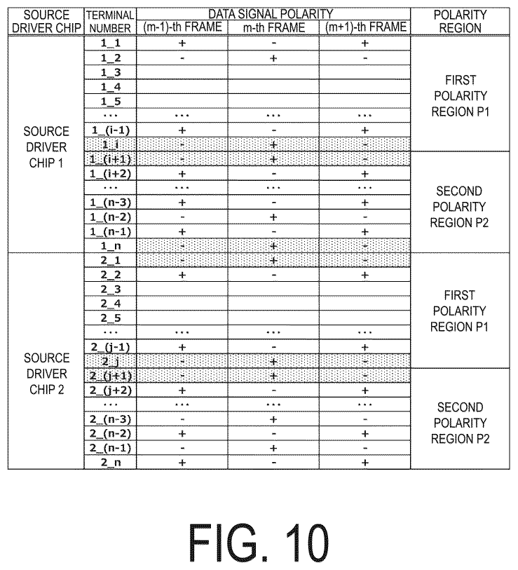

FIGS. 10 to 12 illustrate output examples from the two source driver chips 53a. As illustrated in FIG. 10, a source driver chip 1 and a source driver chip 2 may be controlled by the timing controller 51 to ensure that the polarities of the data signals output to the pair of source bus lines SL adjacent to each other are the same. In the example illustrated in FIG. 10, the data signals of the same polarity are output to the source bus lines SL connected to terminal numbers 1_i and 1_(i+1) of the source driver chip 1, and the data signals of the same polarity are output to the source bus lines SL connected to terminal numbers 2_j and 2_(j+1) of the source driver chip 2. A terminal number 1_n of the source driver chip 1 and a terminal number 2_1 of the source driver chip 2 output the data signals having the same polarity to the pair of source bus lines SL adjacent to each other. Therefore, the boundaries of the polarity regions are formed at the above-described three locations, and the source driver chip 1 and the source driver chip 2 output the data signals to the source bus lines SL located in the first polarity region P1 and the second polarity region P2, respectively.

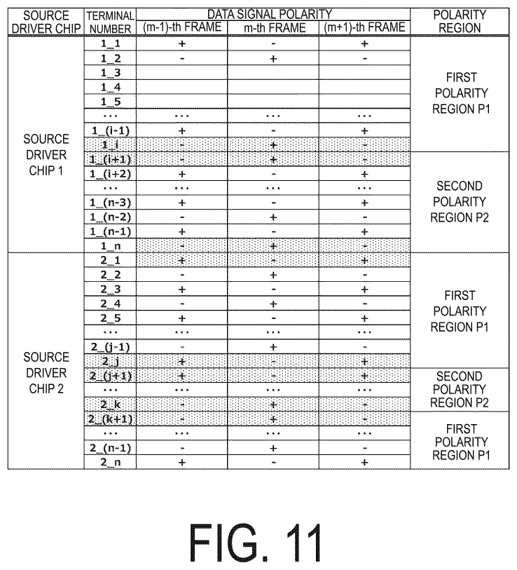

As illustrated in FIG. 11, one source driver chip may be controlled by the timing controller 51 to ensure that the polarities of the data signals output to two or more pairs of source bus lines SL adjacent to each other are the same. In the example illustrated in FIG. 11, the data signals of the same polarity are output to the source bus lines SL connected to the terminal numbers 2_j and 2_(j+1) of the source driver chip 2, and the data signals of the same polarity are output to the source bus lines SL connected to terminal numbers 2_k and 2_(k+1) of the source driver chip 2. Therefore, the source driver chip 2 outputs the data signals to the source bus lines SL located in two first polarity regions P1 and one second polarity region P2.

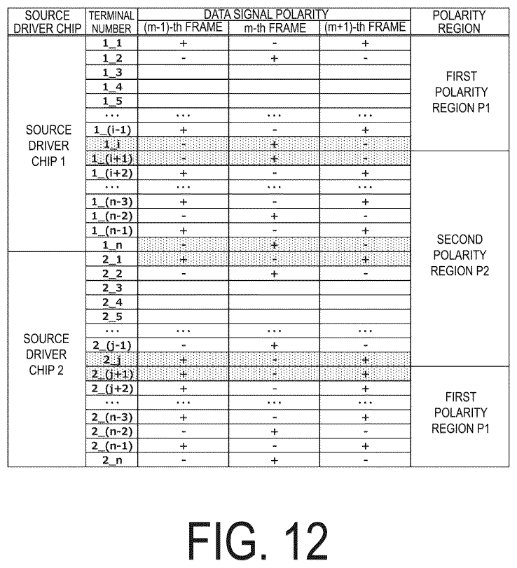

As illustrated in FIG. 12, the terminal number 1_n of the source driver chip 1 and the terminal number 2_1 of the source driver chip 2 may output the data signals having different polarities to the pair of source bus lines SL adjacent to each other. In this case, some of the terminals of the source driver chip 1 and some of the terminals of the source driver chip 2 output the data signals to the source bus lines SL located in one continuous first polarity region P1 or second polarity region P2.

Next, the reason why the color shift occurs when the killer pattern is displayed in the known liquid crystal display device driven by the reversal driving method and the reason why the color shift is suppressed in the liquid crystal display device of the present embodiment will be described.

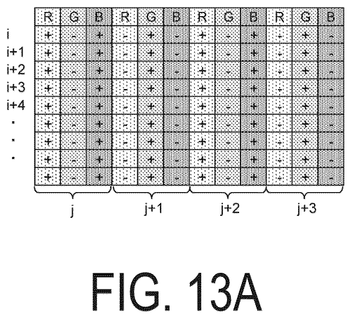

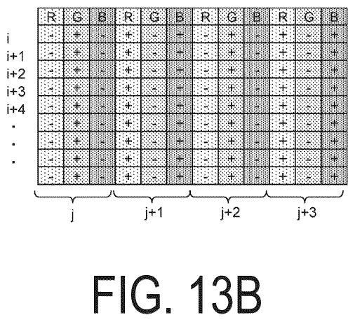

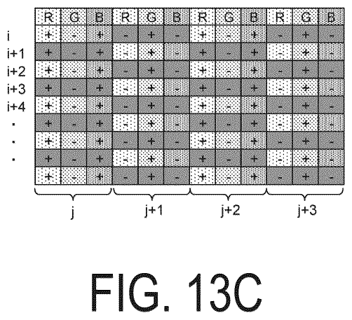

FIGS. 13A and 13B illustrate the polarities of the data signals applied during two consecutive frame periods when the known liquid crystal display device is driven by the column line reversal driving method. FIG. 13C illustrates an example of the killer pattern in the column line reversal driving method. Since the color pixel PXc is constituted of the red pixel R, the green pixel G and the blue pixel B and these pixels are arrayed in the row direction as described above, in a case in which the known liquid crystal display device is driven by the column line reversal driving method, the polarities of the data signals always applied to the red pixel R, the blue pixel B and the green pixel G are inverted to each other.

In this case, as illustrated in FIG. 13C, a checkered pattern in which white display pixels and shaded black display pixels are alternately arranged in the row direction and the column direction for each color pixel PXc unit becomes the killer pattern. In the example illustrated in FIG. 13C, pixels of (i+1), (i+3) . . . in the j-th column and pixels of i, (i+2), (i+4) . . . in the (j+1)-th column are black display pixels. In a case in which the liquid crystal display device is driven in a normally black mode, a voltage is not applied to the liquid crystal layer in a black display pixel.

As illustrated in FIG. 13, in the row direction, since there are pixels displaying black and pixels displaying white in color pixel PXc units, in a case in which the liquid crystal display device is driven in the normally black mode, in a certain frame period, for example, in the i-th pixel row, the data signals are applied to all white display pixels so that the red pixels R and blue pixels B display white with a positive polarity. Thus, in the i-th pixel row, the number of pixel electrodes to which a positive voltage is applied is larger than the number of pixel electrodes to which a negative voltage is applied. In addition, in the (i+1)-th pixel row, the data signals for causing the red pixel R and the blue pixel B to perform the white display with a negative polarity is applied in the all white display pixels, so that the number of the pixel electrodes to which the negative voltage is applied is larger than the number of the pixel electrodes to which the positive voltage is applied. As a result, when the color pixels PXc in each row are sequentially scanned, positive and negative voltages are alternately applied to the pixel electrodes all at once.

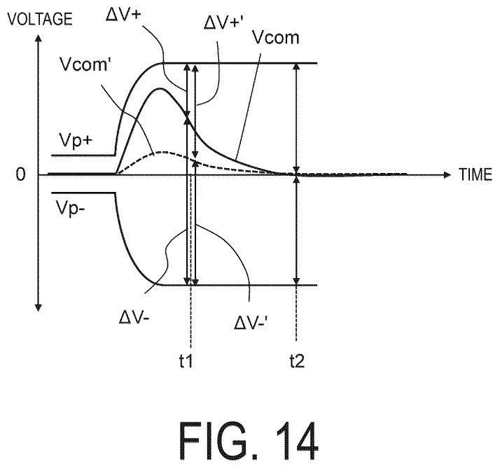

In this case, noise due to the voltage change of the pixel electrode occurs in the common electrode CE, resulting in fluctuation in a potential Vcom of the common electrode, which is supposed to be constant. FIG. 14 schematically illustrates the fluctuation of the pixel electrode and the common electrode in a case in which the data signals are applied to the i-th pixel row in FIG. 13. Although a reference potential is illustrated as 0 V in FIG. 14, the reference potential may be a value other than 0 V.

As illustrated in FIG. 13, since the positive polarity is dominant as the polarity of the voltage of the data signals applied to the pixel electrode, a ripple in which the potential Vcom of the common electrode also fluctuates to a positive side is generated by the application. The generated ripple converges as time passes, and the common electrode returns to the potential Vcom at time t2. At this time, a voltage determined by the difference between a potential Vp+ or Vp− of the pixel electrode and the potential Vcom of the common electrode at the timing when the TFT of each pixel is turned off is applied to the liquid crystal layer of each pixel.

Therefore, as illustrated in FIG. 14, when the TFT is turned off at time t1, in the red pixel R and the blue pixel B to which positive data signals are applied, a voltage ΔV+ applied to the liquid crystal layer becomes small because the potential Vcom of the common electrode also fluctuates to the positive side, and luminance of the red pixel R and the blue pixel B becomes lower than the value determined by the data signals. On the other hand, in the green pixel G to which negative data signals are applied, a voltage ΔV− applied to the liquid crystal layer becomes large because the potential Vcom of the common electrode fluctuates to the positive side, and the luminance of the green pixel G becomes higher than the value determined by the data signals. As a result, the color pixel PXc as a whole is shifted to green color rather than white color.

In a case in which the data signals are applied to the (i+1)-th pixel row, the negative polarity is dominant as the polarity of the voltage of the data signals applied to the pixel electrode, so that the ripple is generated on a negative side in the potential Vcom of the common electrode. At this time, the negative data signals are applied to the red pixel R and the blue pixel B, and the positive data signals are applied to the green pixel G. Therefore, the luminance of the red pixel R and the blue pixel B decreases compared to the value determined by the data signals, and the luminance of the green pixel G increases compared to the value determined by the data signals. As a result, similarly, the color pixel PXc as a whole is shifted to green color rather than white color.

In the next frame period, the voltage applied to each pixel is inverted as illustrated in FIG. 13B. However, since noise occurs in the potential of the common electrode in the pixel electrode having the dominant polarity in the pixel column in each row, the color pixel PXc as a whole is similarly shifted to green color. As can be seen from FIG. 14, as the time t1 during which the TFT is turned off becomes earlier, the fluctuation in the voltage due to the ripple becomes larger, so that the shift of the color pixel PXc to green color becomes remarkable. In other words, the higher the frame frequency is, the more the display image appears green color when the killer pattern is displayed.

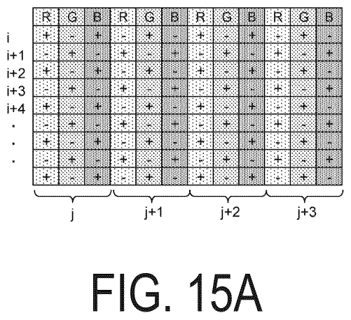

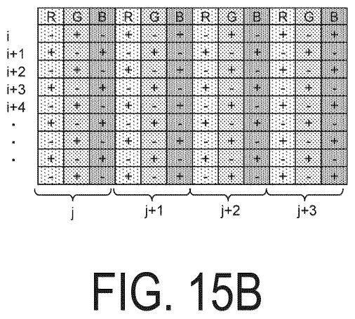

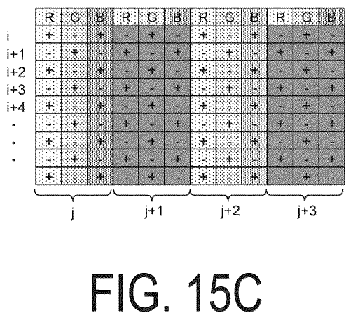

FIGS. 15A and 15B illustrate the polarities of the data signals applied during two consecutive frame periods in a case in which the known liquid crystal display device is driven by the 1H dot inversion drive method. FIG. 15C illustrates an example of the killer pattern in the 1H dot inversion drive method. As illustrated in FIG. 15C, in a case in which the liquid crystal display device is driven by the 1H dot inversion drive method, in the killer pattern, a column of the color pixels PXc for performing white display and a column of the color pixels PXc for performing black display are alternately arranged in the row direction.

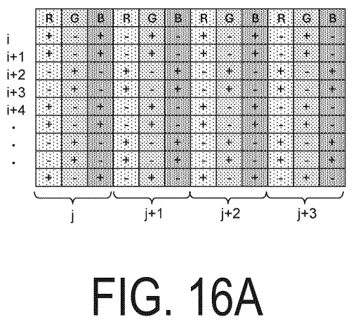

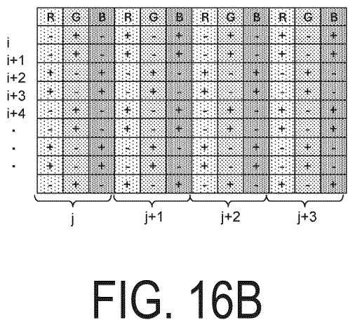

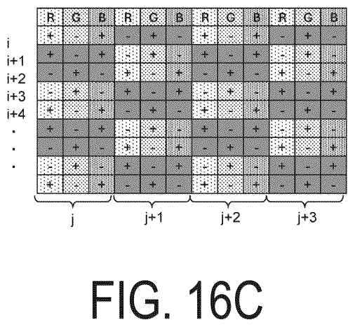

FIGS. 16A and 16B illustrate the polarities of the data signals applied during two consecutive frame periods in a case in which the known liquid crystal display device is driven by the 2H dot inversion drive method. FIG. 16C illustrates an example of the killer pattern in the 2H dot inversion drive method. As illustrated in FIG. 16C, in a case in which the liquid crystal display device is driven by the 2H dot inversion drive method, a checkered pattern in which consecutive two white display pixels and consecutive two black display pixels are alternately arranged in the column direction becomes the killer pattern.

As described above, also in the case in which the liquid crystal display device is driven by the 1H dot inversion drive method and the 2H dot inversion drive method, when the killer pattern is displayed in the known liquid crystal display device, the image shifts to green color.

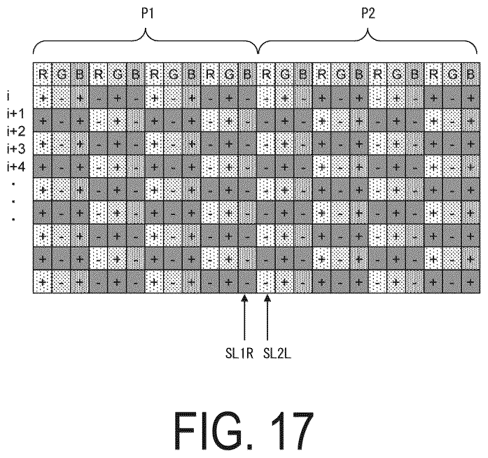

Next, the reason why the color shift is suppressed in the liquid crystal display device of the present embodiment will be described. FIG. 17 illustrates the killer pattern and polarities of the data signals applied in a certain frame period in a case in which the liquid crystal display device of the present embodiment is driven by the column line reversal driving method. As described above, the polarities of the data signals each output to the pair of source bus lines SL1R and SL2L adjacent to each other each included in the first polarity region P1 and the second polarity region P2 adjacent to each other are the same. As illustrated in FIG. 17, in a certain frame period, the polarities of the data signals applied to the pixels located on the source bus line SL1R and the source bus line SL2L are both negative.

In the first polarity region P1 of the i-th pixel row, the data signals for causing the red pixels R and the blue pixels B to perform white display with the positive polarity are applied to all the white display pixels. On the other hand, in the second polarity region P2, the data signals for causing the red pixels R and the blue pixels B to perform white display with the negative polarity are applied to all the white display pixels. Thus, the number of pixel electrodes to which a positive voltage is applied is large in the first polarity region P1 of the i-th pixel row, and the number of pixel electrodes to which a negative voltage is applied is large in the second polarity region P2, so that bias of the polarities of the pixel electrodes in the entire i-th pixel row is suppressed.

In the (i+1)-th pixel row, since the location of the pixel to be displayed in black is shifted, the polarity is inverted. Thus, the number of pixel electrodes to which a negative voltage is applied is large in the first polarity region P1, and the number of pixel electrodes to which a positive voltage is applied is large in the second polarity region P2. As a result, the bias of the polarities of the pixel electrodes in the entire (i+1)-th pixel row is suppressed.

The ripple generated in the potential Vcom of the common electrode may be completely suppressed by ideally offsetting the bias of the polarities of the pixel electrodes in the first polarity region P1 and the bias of the polarities of the pixel electrodes in the second polarity region P2. In this case, the color shift caused by the ripple of the potential Vcom of the common electrode described above can be completely suppressed.

Even in a case in which the ripple is not completely suppressed, the ripple generated in the potential Vcom of the common electrode is reduced as illustrated in FIG. 14 by suppressing the bias of the polarities of the pixel electrodes in the entire i-th pixel row and the entire (i+1)-th pixel row. For example, when the i-th pixel row is scanned, the ripple generated in the potential Vcom′ of the common electrode is reduced by suppressing the bias of the polarities of the pixel electrodes described above, and in a case in which the small ripple of the positive polarity remains, the decrease in a potential difference ΔV+′ between the potential Vp+ of the pixel electrodes in the red pixel and the blue pixel and the potential Vcom′ of the common electrode is suppressed in the first polarity region P1, and the decrease in the luminance in the red pixel and the blue pixel is suppressed. In addition, the increase in a potential difference ΔV−′ between the potential Vp− of the pixel electrode in the green pixel and the potential Vcom′ of the common electrode is suppressed, and the increase in luminance in the green pixel is suppressed. Therefore, in the first polarity region P1, a shift amount of the pixel that performs white display to green color becomes small.

On the other hand, in the second polarity region P2, the negative polarity data signals are applied to the red pixels and the blue pixels, but the small ripple of the positive polarity remains in the potential Vcom of the common electrode in the i-th pixel row. As represented by the potential difference ΔV−′ between the potential Vp− of the pixel electrode in the red pixel and the blue pixel and the potential Vcom′ of the common electrode and the potential difference ΔV+′ between the potential Vp+ of the pixel electrode in the green pixel and the potential Vcom′ of the common electrode, the luminance slightly increases in the red pixel and the blue pixel and the luminance slightly decreases in the green pixel. For this reason, in the second polarity region P2, the pixel displaying white is slightly shifted to magenta color.

As described above, since the fluctuation of the voltage of the common electrode due to the ripple is suppressed, the shift to green color in the first polarity region P1 and the shift to magenta color in the second polarity region P2 are suppressed as compared with the shift to green color in the known liquid crystal display device.

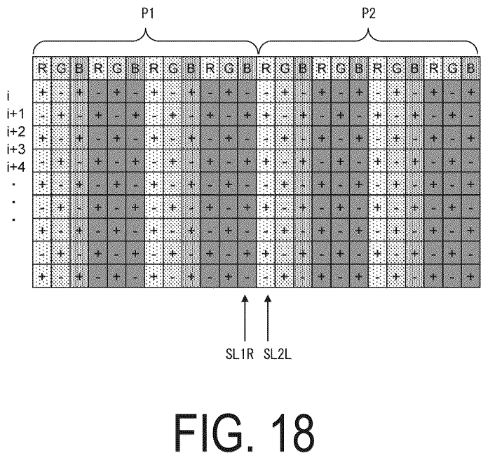

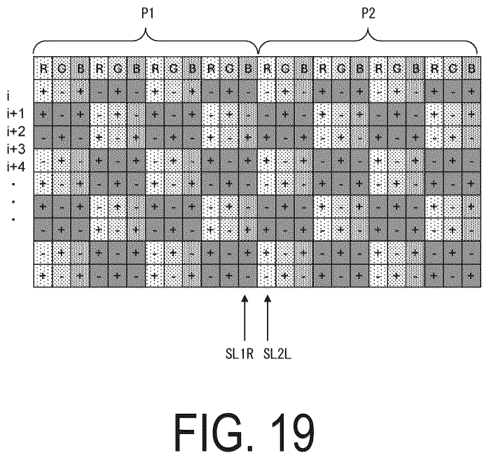

FIG. 18 illustrates the killer pattern and the polarities of the data signals applied in a certain frame period in a case in which the liquid crystal display device of the present embodiment is driven by the 1H dot inversion drive method. FIG. 19 illustrates the killer pattern and the polarities of the data signals applied in a certain frame period in a case in which the liquid crystal display device of the present embodiment is driven by the 2H dot inversion drive method. Also in these driving methods, the color shift in the case of displaying the killer pattern is suppressed as in the case of driving by the column line reversal driving method.

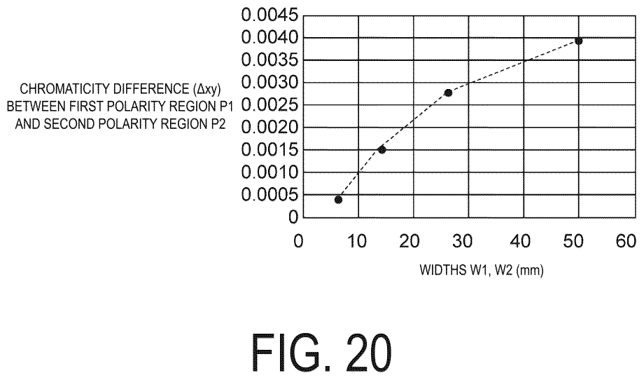

FIG. 20 illustrates an example of a result obtained by measuring the chromaticity of the first polarity region P1 and the second polarity region P2 while changing the widths of the first polarity region P1 and the second polarity region P2 in the row direction using a liquid crystal display device having a pixel density of 200 pixels per inch, and obtaining a chromaticity difference between the first polarity region P1 and the second polarity region P2. As illustrated in FIG. 20, a chromaticity difference Δxy between the first polarity region P1 and the second polarity region P2 changes depending on the widths of the first polarity region P1 and the second polarity region P2 in the row direction. To be more specific, as the widths of the first polarity region P1 and the second polarity region P2 in the row direction become smaller, the chromaticity difference Δxy also becomes smaller. Therefore, it is understood that by providing the plurality of first polarity regions P1 and the plurality of second polarity regions P2, the widths of the first polarity regions P1 and the second polarity regions P2 in the row direction can be reduced, and the chromaticity difference Δxy can also be reduced.

According to a detailed experiment by the inventors of the present application, it was found that when the width W1 in the row direction of the first polarity region P1 and the width W2 in the row direction of the second polarity region P2 are equal to or less than 15 mm, the chromaticity difference Δxy is equal to or less than 0.002, and a stripe pattern due to the difference in color between the first polarity regions P1 and the second polarity regions P2 is hardly visually recognized. Due to the change in the chromaticity difference, it is considered that the regions in which color changes become finer and difficult to be visually recognized not simply because the widths of the first polarity region P1 and the second polarity region P2 decrease, but because the ripple occurring in the reference potential of the common electrode becomes smaller as the width W decreases. In addition, as a result of performing the same measurement on liquid crystal display devices having different pixel densities, it was found that the chromaticity difference can be similarly reduced when the pixel density is from 150 pixels per inch to 300 pixels per inch.

As described above, according to the liquid crystal display device of the present embodiment, in a case in which the column line reversal driving or the dot inversion drive is performed, even when the killer pattern is displayed, the color shift occurring in the image can be suppressed.

A liquid crystal display device and a method for controlling a liquid crystal display device according to the disclosure is not limited to the embodiments described above, and various modifications are possible. For example, the number of source driver chips constituting a source drive circuit can be determined to be an arbitrary value. In addition, in the above embodiment, the source driver chip is driven such that the polarity of the data signals output to the pair of adjacent source bus lines is the same at least one location within each of the source driver chips, but the source driver chip may also be driven so as not to output the data signals of the same polarity to the pair of adjacent source bus lines. By making the polarities of the data signals output from the two source driver chips to the pair of adjacent source bus lines the same, a boundary between the first polarity region and the second polarity region can be provided as described above.

In addition, the liquid crystal display device may separately include a feedback circuit that suppresses the ripple generated in the potential of the common electrode. In this case, since the ripple is suppressed by the configuration of the liquid crystal display device described above, the ripple to be suppressed by the feedback circuit is reduced, and the consumption current of the feedback circuit can be reduced.

In addition, in the liquid crystal display device of the present embodiment, by making the polarities of the data signals applied to the adjacent source bus lines the same, in a case in which there is a possibility that flickering is visually recognized at the time of low-frequency driving, the arrangement and the like of the common electrode can be adjusted so as to reduce parasitic capacitance between the adjacent source bus lines.

A liquid crystal display device and a method for controlling a liquid crystal display device according to the disclosure can be explained as follows.

A liquid crystal display device according a first configuration include a plurality of gate bus lines arranged in a display region, each extending in a row direction and arrayed in a column direction, a plurality of source bus lines arranged in the display region, each extending in the column direction and arrayed in the row direction, a plurality of pixels two-dimensionally arranged in the row direction and the column direction in the display region, each of the plurality of pixels being connected to one of the plurality of gate bus lines and one of the plurality of source bus lines, a source drive circuit connected to the plurality of source bus lines and configured to output a plurality of data signals to each of the plurality of source bus lines by a column line reversal driving method or a dot inversion drive method, and a timing controller configured to control the source drive circuit, in which the display region includes a plurality of first polarity regions and a plurality of second polarity regions extending in the column direction and alternately arranged in the row direction, and the timing controller is configured to control the source drive circuit to ensure that polarities of the data signals each output to a pair of source bus lines are the same, the pair of source bus lines being included in one of the plurality of first polarity regions and one of the plurality of second polarity regions, respectively and adjacent to each other.

According to the first configuration, in a case in which a killer pattern is displayed, fluctuation of potential which may occur in a common electrode can be suppressed, and a color shift of a display image can be suppressed.

A liquid crystal display device according to a second configuration may, in the first configuration, have widths of the first polarity regions and the second polarity regions in the row direction each equal to or less than 15 mm. Accordingly, the color shift of the display image can be more reliably suppressed.

A liquid crystal display device according to a third configuration, in the first configuration, the source drive circuit may include at least one source driver chip configured to output the plurality of data signals, and the timing controller may control the at least one source driver chip to ensure that the polarities of the data signals each output to the pair of source bus lines adjacent to each other are the same.

A liquid crystal display device according to a fourth configuration, in the first configuration, the plurality of pixels may include a plurality of red pixels, a plurality of green pixels, and a plurality of blue pixels, the pixels of the same color may be arranged in the column direction, the red pixel, the green pixel, and the blue pixel may be repeatedly arranged in this order in the row direction, and the pair of source bus lines to which the data signals of the same polarity are output may be located at the red pixels and the blue pixels, respectively.

A method for controlling a liquid crystal display device according to a fifth configuration is a method for controlling a liquid crystal display device including a plurality of gate bus lines arranged in a display region, each extending in a row direction and arrayed in a column direction, a plurality of source bus lines arranged in the display region, each extending in the column direction and arrayed in the row direction, a plurality of pixels two-dimensionally arranged in the row direction and the column direction in the display region, each of the plurality of pixels being connected to one of the plurality of gate bus lines and one of the plurality of source bus lines, a source drive circuit connected to the plurality of source bus lines and configured to output a plurality of data signals to each of the plurality of source bus lines by a column line reversal driving method or a dot inversion drive method, and a timing controller configured to control the source drive circuit, in which the display region includes a plurality of first polarity regions and a plurality of second polarity regions extending in the column direction and alternately arranged in the row direction, and the timing controller is configured to control the source drive circuit to ensure that polarities of the data signals each output to a pair of source bus lines are the same, the pair of source bus lines being included in one of the plurality of first polarity regions and one of the plurality of second polarity regions, respectively and adjacent to each other.

According to the fifth configuration, in a case in which the killer pattern is displayed, the fluctuation of the potential which may occur in the common electrode can be suppressed, and the color shift of the display image can be suppressed.

A method for controlling a liquid crystal display device according to a sixth configuration may, in the fifth configuration, have widths of the first polarity regions and the second polarity regions in the row direction each equal to or less than 15 mm.

A method for controlling a liquid crystal display device according to a seventh configuration, in the fifth configuration, the source drive circuit may include at least one source driver chip that outputs the plurality of data signals, and the timing controller may control the at least one source driver chip to ensure that the polarities of the data signals each output to the pair of source bus lines adjacent to each other are the same.

A liquid crystal display device according to an eighth configuration, in the fifth configuration, the plurality of pixels may include a plurality of red pixels, a plurality of green pixels, and a plurality of blue pixels, the pixels of the same color may be arranged in the column direction, the red pixel, the green pixel, and the blue pixel may be repeatedly arranged in this order in the row direction, and the pair of source bus lines to which the data signals of the same polarity are output may be located at the red pixels and the blue pixels, respectively.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device, comprising:
a plurality of gate bus lines arranged in a display region, each extending in a row direction and arrayed in a column direction;
a plurality of source bus lines arranged in the display region, each extending in the column direction and arrayed in the row direction;
a plurality of pixels two-dimensionally arranged in the row direction and the column direction in the display region, each of the plurality of pixels being connected to one of the plurality of gate bus lines and one of the plurality of source bus lines;
a source drive circuit connected to the plurality of source bus lines and configured to output a plurality of data signals to each of the plurality of source bus lines by a column line reversal driving method or a dot inversion drive method; and
a timing controller configured to control the source drive circuit,
wherein the display region includes a plurality of first polarity regions and a plurality of second polarity regions extending in the column direction and alternately arranged in the row direction, and
the timing controller is configured to control the source drive circuit to ensure that polarities of the data signals each output to a pair of source bus lines are identical, the pair of source bus lines being included in one of the plurality of first polarity regions and one of the plurality of second polarity regions, respectively and adjacent to each other.

2. The liquid crystal display device according to claim 1,
wherein widths of the first polarity regions and the second polarity regions in the row direction are each equal to or less than 15 mm.

3. The liquid crystal display device according to claim 1,
wherein the source drive circuit includes at least one source driver chip configured to output the plurality of data signals, and the timing controller is configured to control the at least one source driver chip to ensure that the polarities of the data signals each output to the pair of source bus lines adjacent to each other are identical.

4. The liquid crystal display device according to claim 1,
wherein the plurality of pixels include a plurality of red pixels, a plurality of green pixels, and a plurality of blue pixels,
the pixels of an identical color are arranged in the column direction,
the red pixel, the green pixel, and the blue pixel are repeatedly arranged in this order in the row direction, and
the pair of source bus lines to which the data signals of the identical polarity are output are located at the red pixels and the blue pixels, respectively.

5. A method for controlling a liquid crystal display device including a plurality of gate bus lines arranged in a display region, each extending in a row direction and arrayed in a column direction, a plurality of source bus lines arranged in the display region, each extending in the column direction and arrayed in the row direction, a plurality of pixels two-dimensionally arranged in the row direction and the column direction in the display region, each of the plurality of pixels being connected to one of the plurality of gate bus lines and one of the plurality of source bus lines, a source drive circuit connected to the plurality of source bus lines and configured to output a plurality of data signals to each of the plurality of source bus lines by a column line reversal driving method or a dot inversion drive method, and a timing controller configured to control the source drive circuit,
wherein the display region includes a plurality of first polarity regions and a plurality of second polarity regions extending in the column direction and alternately arranged in the row direction, and
the timing controller is configured to control the source drive circuit to ensure that polarities of the data signals each output to a pair of source bus lines are identical, the pair of source bus lines being included in one of the plurality of first polarity regions and one of the plurality of second polarity regions, respectively and adjacent to each other.
